(19) United States
(12) Patent Application Publication
(10) Pub. No.: US 2014/0280237 A1
(43) Pub. Date: Sep. 18, 2014

(54) METHOD AND SYSTEM FOR IDENTIFYING SETS OF SOCIAL LOOK-ALIKE USERS

(71) Applicant: SHARE THIS INC., Palo Alto, CA (US)

(72) Inventors: Markku Salkola, Palo Alto, CA (US); Chao Qin, Sunnyvale, CA (US); Changyi Zhu, San Jose, CA (US); Prasanta Behera, Cupertino, CA (US); Yan Qu, Los Altos, CA (US)

(73) Assignee: SHARE THIS INC., Palo Alto, CA (US)

(21) Appl. No.: 13/845,512

(22) Filed: Mar. 18, 2013

(51) Int. Cl. G06F 17/30

(52) U.S. Cl. CPC G06F 17/30861
USPC 707/749

(57) ABSTRACT

Systems and methods are disclosed for identifying a set of social look-alike users from a plurality of users. In an embodiment, a first set of users is selected from the plurality of users based, at least in part, on one or more characteristics associated with the plurality of users. A degree of similarity is determined between the first set of users and the plurality of users. The plurality of users is ranked based on the degree of similarity and thereafter the set of social look-alike users is determined based on the ranking.

### TECHNICAL FIELD

The disclosure relates, in general, to a data collection and analysis system. More specifically, the disclosure relates to a system for determining social look-alikes of online users based on their online activities.

### BACKGROUND

With the advent of advanced communication technologies and globalization of communication standards, internet usage, in general, has seen multi-fold growth in the last few years. At any instant, there may be millions of users involved in a variety of activities on the internet. Due to a wide scope and reach of the internet, various commercial and non-commercial firms such as, but not limited to, the advertisements firms, online shopping firms, consumer electronics firms, and retail stores, own and maintain one or more websites. Usually, the firms may invest considerable amount of resources to maintain the websites.

### SUMMARY

A computer-implemented method for identifying a set of social look-alike users from a plurality of users is provided, the plurality of users accessing a plurality of web pages. The computer-implemented method includes selecting a first set of users from the plurality of users based on one or more characteristics associated with the plurality of users. A degree of similarity is then determined between the first set of users and the plurality of users based on a set of similarity parameters. The plurality of users is ranked based on the degree of similarity, and the set of social look-alike users is determined based on the ranking.

A computer-implemented method for identifying a set of social look-alike users from a plurality of users accessing a plurality of web pages is provided. The computer-implemented method comprises selecting a first set of users from the plurality of users based at least in part on weights assigned to one or more characteristics associated with the plurality of users. The weights are assigned to the one or more characteristics based on one or more features of an ad campaign. The first set of users has one or more common characteristics. The computer-implemented method comprises determining a degree of similarity between the first set of users and the plurality of users. The computer-implemented method comprises ranking the plurality of users based on the degree of similarity; and determining the set of social look-alike users from the ranked plurality of users.

A web analytic server for identifying a set of social look-alike users from a plurality of users accessing a plurality of web pages is also provided. The web analytic server comprises a first user selection module configured to select a first set of users from the plurality of users based at least in part on weights assigned to one or more characteristics associated with the plurality of users. The weights are assigned based on one or more features of a campaign. The users in the first set of users have one or more common characteristics. The web analytic server comprises an analysis module configured to determine the set of social look-alike users from the plurality of users based at least in part on the one or more common characteristics.

A web analytic server for identifying a set of social look-alike users from a plurality of users accessing a plurality of web pages is further provided. The web analytic server comprises a first user selection module configured to select a first set of users from the plurality of users based on one or more log records associated with the plurality of users. The one or more log records are indicative of at least one user activity on at least one web page. The at least one user activity comprises a sharing or clicking activity. The web analytic server further comprises a second user selection module configured to select a second set of users for the first set of users based at least in part on the at least one log record associated with the first set of users. The second set of users and the first set of users have one or more common characteristics. The web analytic server comprises an analysis module configured to determine the set of social look-alike users from the second set of users based, at least in part, on one or more log records associated with the second set of users and a predetermined data set.

A computer-implemented method for identifying a set of social look-alike users from a plurality of users accessing a plurality of web pages is also provided. The computer-implemented method comprises selecting a first set of users from the plurality of users based on one or more log records associated with the plurality of users. The one or more log records are indicative of at least one user activity on at least one web page. The at least one user activity comprises a sharing or clicking activity. The computer-implemented method comprises selecting a second set of users for the first set of users based at least in part on at least one log record associated with the first set of users. The second set of users and the first set of users have one or more common characteristics. The computer-implemented method comprises determining the set of social look-alike users from the second set of users based at least in part on one or more log records associated with the second set of users and a predetermined data set.

A computer-implemented method for generating a social look-alike model is further provided. The computer-implemented method comprises selecting a first set of users from a plurality of users based at least in part on one or more log records. The one or more log records are indicative of at least one user activity. The at least one user activity comprises a sharing or clicking activity. The computer-implemented method further comprises selecting a second set of users based at least in part on the first set of users and at least one log record associated with the first set of users. The computer-implemented method further comprises selecting a set of social look-alike users from the second set of users based at least in part on one or more log records associated with the second set of users and a predetermined data set. The computer-implemented method comprises calculating a probability that a user in the set of social look-alike users will respond to a campaign based at least in part on the predetermined data set. The computer-implemented method comprises generating the social look-alike model based at least in part on the probability and the set of social look-alike users.

### BRIEF DESCRIPTION OF DRAWINGS

The following detailed description of the embodiments of the disclosed invention will be better understood when read with reference to the appended drawings. The invention is illustrated by way of example, and is not limited by the accompanying figures, in which like references indicate similar elements.

FIG. 1 illustrates a data collection system in accordance with an embodiment of the invention;

FIG. 2 illustrates a web analytic server in accordance with an embodiment of the invention;

FIG. 3 illustrates an exemplary representation of social look-alike data in accordance with an embodiment of the invention;

FIG. 4 illustrates a flowchart illustrating a method to determine a set of social look-alike users in accordance with an embodiment of the invention;

FIG. 5 illustrates a flowchart illustrating a method to determine a set of social look-alike users in accordance with an embodiment of the invention;

FIG. 6 illustrates a flowchart illustrating a method to generate a social look-alike model in accordance with an embodiment of the invention;

FIG. 7 illustrates an exemplary graph illustrating selection of second set of users in accordance with an embodiment of the invention; and

FIG. 8 illustrates a flowchart illustrating a method to generate a social look-alike model in accordance with an embodiment of the invention.

### DETAILED DESCRIPTION

The disclosure can be best understood with reference to the detailed figures and description set forth herein. Various embodiments are discussed below with reference to the figures. However, those skilled in the art will readily appreciate that the detailed description given herein with respect to these figures is just for explanatory purposes as methods and systems of the invention may extend beyond the described embodiments.

Definition of Terms:

User activity: User activity corresponds to various activities performed by a user browsing the Internet. For example, the user activity can be a sharing activity, a clicking activity, a searching activity, purchasing activity, and a web page view activity. Sharing activity may correspond to a user activity in which a user shares web content with other users of the Internet. Clicking activity may correspond to a user activity in which a user clicks on web content. Searching activity corresponds to a user activity in which a user searches for web content on the Internet.

Log record: A log record is metadata that is indicative of user activities performed on the Internet. Further, a log record may include a cookie, a timestamp, an event type, a social channel, a content identifier, domain information, and a browser agent.

Campaign: A campaign comprises data/information that is directed to a specific group of users. The campaign has one or more features that define various aspects of the campaign such as, but are not limited to, one or more events, one or more websites for hosting the campaign, duration of the one or more events, and categories of the one or more events. Some of the examples of a campaign may include, but are not limited to, advertisement campaign, marketing campaign, political campaign, etc.

Predetermined data set: A predetermined data set corresponds to information related to a campaign. The predetermined data set may include keywords associated with the campaign, a social optimization pixel on a web page hosted by a web server, campaign responses, and at least one content category associated with the campaign. Examples of a predetermined data set may include, but are not limited to, advertisement campaign data, and survey data.

Social sharing graph: A social sharing graph corresponds to a graphical representation of links prevailing between users. The links are indicative of user relations, such as sharing of similar interests (e.g., an interest graph), proximity of locations (e.g., location-based social networks), or communication connections (e.g., email networks).

Social look-alike users: Social look-alike users correspond to a set of target users that have a high probability of responding to a campaign. For example, the social look-alike users will have a high probability of converting an advertisement campaign into a sales closure. The social look-alike users may have one or more common characteristics.

FIG. 1 illustrates a data collection system 100 in accordance with an embodiment of the invention. The data collection system 100 includes a network 102, a web analytic server 104, an advertising server 106, a database 108, a plurality of domain web servers 110a, 110b, and 110c (generally referred to as 110) and a plurality of computing devices 112a, 112b, and 112c (generally referred to as 112).

The network 102 corresponds to a medium through which the content and the messages flow between the various components of the data collection system 100 (e.g. the plurality of computing devices 112a, 112b, and 112c, the web analytic server 104, the database 108, the domain web server 110). Examples of the network 102 may include, but are not limited to, a television broadcasting system, an IPTV network, a Wireless Fidelity (WiFi) network, a Wide Area Network (WAN), a Local Area Network (LAN) or a Metropolitan Area Network (MAN). Various devices in the data collection system 100 can connect to the network 102 in accordance with various wired and wireless communication protocols such as Transmission Control Protocol and Internet Protocol (TCP/IP), User Datagram Protocol (UDP), and 2G, 3G or 4 G communication protocols.

In an embodiment, the web analytic server 104 corresponds to a web analytic system having capabilities to extract and analyze data for commercial purposes. The web analytic server 104 may extract the data using various querying languages, such as, Structured Query Language (SQL), 4D Query Language, Object Query Language, and Stack Based Query Language (SBQL). Further, the web analytic server 104 includes various analytical tools for identifying a set of social look-alike users for commercial purposes. Examples of such analytical tools may include, but are not limited to, a tracking tool, a social behaviour analytic tool, a social look-alike analytic tool, a probability calculation tool, audience segmentation, user modelling, campaign analytics, audience analytics, a campaign optimization tool, etc.

The advertising server 106 may correspond to a web server hosting one or more advertisement domains (web sites). For example, the advertising server 106 may host an online shopping web site or domain that offers products of one or more categories and/or brands, for example, www.buyfor.com. The advertising server 106 may include a predetermined data set associated with the one or more advertisement domains. In an embodiment, the predetermined data set may correspond to advertisement campaign data and survey data. In an embodiment, the advertising server 106 stores the predetermined data set in the database 108. The advertising server 106 can be configured to store and publish advertisements/surveys associated with the predetermined data set across one or more domain web servers 110 (e.g. 110a). Examples of advertising server 106, may include, but are not limited to, FTP server, HTTP server, mail server, and proxy server, etc.

The database 108 corresponds to a storage device that stores collected data. In an embodiment, the data can include a social sharing graph, log records corresponding to the user activities on the plurality of web sites, etc. The database 108 can be implemented by using several technologies that are well known to those skilled in the art. Some examples of such technologies may include, but are not limited to, MySQL®, Microsoft SQL®, etc. In an embodiment, the database 108 may be implemented as cloud storage. Examples of cloud storage may include, but are not limited to, Amazon E3®, Hadoop® distributed file system, etc.

The domain web server 110 may correspond to a web server that includes data and information required to host one or more web sites. In an embodiment, the domain web server 110 may install a tracking component that is configured to track and store one or more user activities on the one or more web sites as one or more log records. In an embodiment, the domain web server 110 stores the one or more log records on the database 108. Examples of the domain web server 110 may include, but are not limited to, Apache® web server, Microsoft® IIS server, Sun® Java System Web Server, etc.

The computing device 112 may correspond to a device capable of receiving an input from a user. Examples of the computing device 112 may include, but are not limited to, laptops, television (TV), tablet computers, desktops, mobile phones, gaming consoles and other such devices having capabilities of receiving the user input. Further, each of the plurality of computing devices 112 (e.g. 112a, 112b, and 112c) may include a user interface that provides a user an option to navigate through a content on a web page. Although three computing devices have been shown in the figure, it may be appreciated that the disclosed embodiments can be implemented with a large number and different types of computing devices from different manufacturers. It may also be appreciated that, for a larger number of computing devices, the web analytic server 104 may be implemented as a cluster of computing devices configured to jointly perform the functions of the web analytic server 104.

In operation, a user (not shown) associated with at least one of the plurality of computing devices 112 (e.g. 112a) may browse through the one or more websites hosted by the plurality of domain web servers 110 (e.g. 110a). The user performs one or more user activities on the one or more websites. The plurality of domain web servers 110 hosts one or more web pages that include a tracking component. The tracking component tracks and stores one or more log records corresponding to such user activities in the database 108.

The web analytic server 104 extracts the one or more log records from the database 108. Thereafter, based on the one or more log records, the web analytic server 104 determines one or more characteristics associated with a plurality of users. In an embodiment, the one or more characteristics may include a genre of web content that has been subject to the one or more user activities, user interests, user response behaviour, social events, user feature data etc. Based on the determined one or more characteristics, the web analytic server 104 generates a user profile for the plurality of users. In an embodiment, the user profile is indicative of the one or more characteristics. In an embodiment, the user profile may include username, password, user interests, etc.

Concurrently, the web analytic server 104 receives a predetermined data set from the advertising server 106. In an alternative embodiment, the web analytic server 104 extracts the predetermined data set from the database 108. In an embodiment, the predetermined data set corresponds to an ad campaign having one or more features. The one or more features of the ad campaign comprise content of the ad campaign, duration of the ad campaign, and metadata of websites publishing the ad campaign. Thereafter, the web analytic server 104 assigns weights to the one or more characteristics associated with the user profile for the plurality of users based on the one or more features of the ad campaign. In an embodiment, the web analytic server 104 assigns weights to the one or more characteristics using a similarity function. Some of the examples of the similarity function include a cosine function, etc. In an embodiment, the weights assigned to the one or more characteristics lies in the range of zero (0) and one (1).

Based on the weights assigned to the one or more characteristics, the web analytic server 104 selects a first set of users from the plurality of users. Thereafter, the web analytic server 104 analyzes the one or more characteristics associated with the user profiles of preferably each user in the first set of users to determine one or more common characteristics.

The web analytic server 104 compares the one or more common characteristics associated with the user profiles of preferably each user in the first set of users with the one or more characteristics associated with each of the plurality of users to determine a set of social look-alike users.

In an embodiment, the set of social look-alike users can be determined from a social sharing graph. The web analytic server 104 generates the social sharing graph based on the one or more log records associated with the plurality of users. In an embodiment, the social sharing graph depicts relationship between the plurality of users across the network 102 based on the one or more log records. For example, user A shares web content with user B and user C. The social sharing graph will depict user A connected to user B and user C. In an embodiment, the social sharing graph depicts the connection between user A, user B and user C through a link. In an embodiment, the link or edge is weighted based on the strength of relationship between the user A, user B, and user C.

In an embodiment, the social sharing graph further adopts a rich annotation scheme. The rich annotation scheme is highly scalable and durable given the node-centric storage of the social sharing graph. That is, each edge can be associated with multiple URLs and each URL can have multiple labels, e.g., its top content categories, its related brand names, its social channel (indicating where it is shared or clicked), its timestamp (indicating when it is shared or clicked). For example, user A shares web content about shopping for shoes with user B and another web content about business with user C. If the social sharing graph is intended for capturing social behaviours of users on the shopping sites, the weight on the link between user A and B will be significantly higher than that between user A and C. This helps the quality of subsequent social look-alike users for audience targeting.

In an embodiment, the web analytic server 104 receives the predetermined data set from the advertising server 106. Based on the predetermined data set and the one or more log records associated with the plurality of users, the web analytic server 104 selects a first set of users from the plurality of users depicted in the social sharing graph. Thereafter, the web analytic server 104 selects a second set of users from the plurality of users for preferably each of the first set of users based on the one or more log records associated with the first set of users. In an embodiment, the first set of users and the second set of users have one or more characteristics in common. In an embodiment, the one or more characteristics may include, but are not limited to, user interests and user activities. In an embodiment, the web analytic server 104 qualitatively and/or quantitatively analyzes the one or more log records associated with the first set of users. For example, user A shares a web content with user B and user C. User B does not perform any user activity on the web content. On the other hand, user C performs one or more user activities on the web content shared by the user A. Thus, the second set of users would include user C rather than user B.

Finally, based on the one or more log records associated with the second set of users and the predetermined data set, the web analytic server 104 extracts a set of social look-alike users from the second set of users. The set of social look-alike users are potential users that might respond to a campaign associated with the predetermined data set.

For example, the predetermined data set corresponds to an advertisement campaign data for Macys®. The web analytic server 104 would determine one or more log records related to Macys®. Thereafter, the web analytic server 104 identifies the first set of users associated with the one or more log records. Each of the first set of users might have performed one or more user activities on the web content related to Macys®.

Thereafter, the web analytic server 104 analyzes the one or more log records associated with each of the first set of users to identify a second set of users. The second set of users might have performed one or more user activities on web content shared or clicked by the first set of users. The second set of users may include users that have one or more characteristics in common with users in the first set of users. Based on one or more log records associated with the second set of users and Macys® advertisement campaign data, the web analytic server 104 determines a set of social look-alike users from the second set of users. In an embodiment, the set of social look-alike users may include users having a high probability of responding to Macys® advertisement campaign. Further, the set of social look-alike users may include users that may have not performed one or more user activities on web content related to Macys® to date but have responded to similar advertisement campaigns.

FIG. 2 illustrates a block diagram of a web analytic server 104 in accordance with an embodiment of the invention. The web analytic server 104 includes a processor 202, a user input device 204, and a memory device 206. The web analytic server 104 is explained in conjunction with FIG. 1.

The processor 202 is coupled to the user input device 204 and the memory device 206. The processor 202 is configured to execute a set of instructions stored in the memory device 206. The processor 202 can be realized through a number of processor technologies known in the art. Examples of the processor 202 can be, but are not limited to, X86 processor, RISC processor, ASIC processor, CSIC processor, or any other processor. The processor 202 fetches the set of instructions from the memory device 206 and executes the set of instructions.

The user input device 204 receives a user input. Examples of the user input device 204 may be, but are not limited to, a keyboard, a mouse, a joystick, a gamepad, a stylus or a touch screen.

The memory device 206 is configured to store data and a set of instructions or modules. Some of the commonly known memory device implementations can be, but are not limited to, a random access memory (RAM), read only memory (ROM), hard disk drive (HDD), and secure digital (SD) card. The memory device 206 includes a program module 208 and a program data 210. The program module 208 includes a set of instructions that is executed by the processor 202 to perform specific actions on the web analytic server 104. The program module 208 further includes a social sharing graph manager 212, a first user selection module 214, a second user selection module 216, an analysis module 218, a social look-alike manager 220, a data extraction module 222, a user profile creation module 224, a ranking module 226, and a training module 228. Although various modules in the program module 208 are shown in separate blocks, it may be appreciated that one or more of the modules may be implemented as an integrated module performing the combined functions of the constituent modules.

The program data 210 includes log record data 230, social look-alike data 232, social sharing data 234, probability data 236, and a predetermined data set 238.

The social sharing graph manager 212 constructs one or more social sharing graphs based on the log record data 230 of the plurality of users. The log record data 230 stores the one or more log records of the plurality of users. Further, the social sharing graph manager 212 stores the social sharing graph in the program data 210 as social sharing data 234. In another embodiment, the social sharing graph manager 212 constructs one or more social structures based on the log record data 230 of the plurality of users. The log record data 230 stores the one or more log records of the plurality of users. Further, the social sharing graph manager 212 stores the social structures in the program data 210 as social sharing data 234. In yet another embodiment, the social sharing graph manager 212 constructs one or more social sharing graphs based on the log record data 230 of the plurality of users. The log record data 230 stores the one or more log records of the plurality of users. Further, the social sharing graph manager 212 stores the sharing graphs in the program data 210 as social sharing data 234.

The first user selection module 214 selects a first set of users (such as seed users) from the predetermined data set 238 comprising a plurality of users. In an embodiment, the first set of users is selected based on the one or more characteristics stored in the log record data 230. In an embodiment, the first user selection module 214 can be implemented using various algorithms known in the art. Some examples of such algorithms may be, but are not limited to, heuristic algorithms, fuzzy logic algorithms, etc. In an embodiment, the first user selection module 214 selects the first set of users from the plurality of users based on weights assigned to one or more characteristics associated with preferably each of the plurality of users. In an embodiment, the weights are assigned based on one or more features of an ad campaign.

The second user selection module 216 selects a second set of users based on a degree of similarity between the first set of users and the plurality of users based on a set of similarity parameters. In an embodiment, the second set of users selected from the plurality of users are the social look-alike users such that the second set of users are related to the first set of users in at least one way. In an embodiment, the second user selection module 216 is further configured to compare user profiles of the first set of users and the plurality of users, and thereafter computes a look-alike profile by aggregating the first set of users' profiles or by using supervised learning. In another embodiment, the second user selection module 216 is configured to identify one or more users from the plurality of users having a pre-defined proximity distance from the first set of users in a social sharing graph. The second user selection module 216 may select the one or more users from the plurality of users connected to the first set of users in a social sharing graph directly or indirectly. In an example, the users connected to the first set of users are regarded as distance-1 friends and the users connected to the distance-1 friends are regarded as distance-2 friends, and so on. The plurality of users is discovered from the closest to the farthest distance from the first set of users. At each distance, the newly discovered friends are used as seed users to find more friends at the next farther distance. They, alone or combined with the friends discovered at other distances, will be used to form the second set of users, which in turn will be ranked by how strongly they are connected to the first set of users. The ranking for both embodiments is performed in the ranking module 226, detailed as follows.

The analysis module 218 is configured to identify a set of social look-alike users from the plurality of users. In an embodiment, the analysis module 218 calculates a probability for preferably each user in the set of social look-alike users based on the predetermined data set 238. In an embodiment, the predetermined data set corresponds to at least one of an ad campaign data, and survey data. In another embodiment, the analysis module 218 empirically evaluates offline audience segments and results are further used in multivariate analysis. The analysis module 218 can also be used to evaluate the various ranking schemes. The analysis module 218 may include analytical tools such as, but not limited to, a tracking tool, a social behaviour analytic tool, a probability calculation tool, audience segmentation, user modelling, campaign analytics, audience analytics, and a campaign optimization tool.

The social look-alike manager 220 is configured to generate a social look-alike graph based on the probability data 236. In some embodiments, the social look-alike manager 220 manages the first user selection module 214, the second user selection module 216, and the ranking module 226. The social look-alike manager 220 is responsible for producing one or more social look-alike audience segments by leveraging social data along with other online data, e.g., search data, page view data, and/or the like.

The data extraction module 222 is configured to extract and process data from the database 108. In an embodiment, the data extraction module 222 extracts the data from the log record data 230 and the predetermined data set 238. In an embodiment, the data extraction module 222 processes the log record data 230 and the predetermined data set 238 for creating tables in a predefined format. The data extraction module 222 extracts the data using various querying languages, such as Structured Query Language (SQL), 4D Query Language, Object Query Language, and Stack Based Query Language (SBQL).

The user profile creation module 224 is configured to create a user profile for preferably each of the plurality of users based on the one or more characteristics. In an embodiment, the one or more characteristics are determined based on one or more log records associated with each of the plurality of users. The one or more log records indicate at least one user activity on at least one web page. In an embodiment, the user profile creation module 224 is configured to build user profiles from users' online behaviours.

The ranking module 226 ranks the plurality of users in the data network by degrees of similarity of their user profiles to the look-alike profiles and selects top ranked users as the second set of users. In an embodiment, the ranking module 226 selects a set of social look-alike users (as an audience segment to target) from the plurality of users.

In an embodiment, the plurality of users is ranked by the ranking module 226 based on degrees of similarity of the profiles of the plurality of users to a look-alike profile. The degree of similarity is determined based on a set of similarity parameters. The set of similarity parameters comprises at least one of common user features, weights assigned to user features and one or more parameters associated with a social sharing graph.

In an embodiment, the look-alike profile is computed from user profiles of the first set of users. The top ranked plurality of users is selected as a second set of users to target. In another embodiment, one or more metadata may be used to rank the plurality of users and select top-ranked users to target. For example, the plurality of users set by default contains users that connect to all other users. In the embodiment, it is assumed that all the users in the second set are equally likely to respond to a campaign. However, the users that are connected to multiple seed users may have a higher likelihood to take action on the ad than those connected merely to a single seed user. By differentiating the plurality of users in this way, one can target those users with multiple and strong connections to the first set of users. In an embodiment, the ranking module 226 uses one or more similarity functions to assign weights to the one or more characteristics. An example of a similarity function includes, but is not limited to, a cosine function. Based on the weights, the ranking module 226 ranks the user profiles associated with preferably each of the plurality of users in order of their relevancy with the predetermined data set 238.

In an embodiment, the training module 228 is configured to train the first user selection module 214, the analysis module 218, and the second user selection module 216 based on the one or more user activities performed by the set of social look-alike users. In an embodiment, the training module 228 uses one or more known techniques, for example neural network, fuzzy-neural network, regression model, and/or the like.

FIG. 3 illustrates an exemplary social look-alike graph 300 in accordance with an embodiment of the invention. FIG. 3 is explained in conjunction with FIG. 1 and FIG. 2.

The social look-alike graph 300 includes concentric circles 302, 304, 306, and 308. The circle 302 represents the first set of users or seed users. Circle 304 represents a first set of one or more users 310a, 310b, and 310c from a set of social look-alike users that are at a distance P1 316 from the circle 302. In an embodiment, distance P1 316 corresponds to an average probability P1 or marginal probability associated with the first one or more users 310a, 310b, and 310c. A person skilled in the art would appreciate that the probability associated with each of the first one or more users 310a, 310b, and 310c may be different. The average probability P1 is calculated in order to segment the users in the set of social look-alike users in various groups or segments. In another embodiment, probabilities associated with the first one or more users 310a, 310b, and 310c fall in a predefined range of probabilities. Based on the predefined range of probabilities, the set of social look-alike users are segmented in various groups or segments. Similarly, circle 306 represents a second set of one or more users 312a, 312b, and 312c from the set of social look-alike users that are a distance of P2 318 from the circle 302. In an embodiment, the marginal probability associated with the second one or more users 312a, 312b, and 312c is comparatively less than the marginal probability associated with the first one or more users 310a, 310b, and 310c. It should be appreciated by a person skilled in the art that the disclosure should not be limited to representing the set of social look-alike users in the social look-alike graph 300 based on the probability. Any other data representation scheme can be used for representing the set of social look-alike users based on the probability.

FIG. 4 illustrates a method to determine a set of social look-alike users in accordance with an embodiment of the invention. FIG. 4 is explained in conjunction with FIG. 1 and FIG. 2.

At step 402, a predetermined data set is received by the data extraction module 222. In an embodiment, the data extraction module 222 receives the predetermined data set from an advertising server 106. Further, the data extraction module 222 stores the received predetermined data set in the program data 210 as the predetermined data set 238. Concurrently, the data extraction module 222 extracts one or more log records associated with a plurality of users of a predetermined data set 238 in the network 102.

At step 404, the first set of users is selected from the plurality of users of the pre-determined dataset. In an embodiment, the first user selection module 214 selects the first set of users from the plurality of users based on the weights assigned to the one or more characteristics associated with preferably each of the plurality of users. In an embodiment, the weights are assigned based on the one or more features of the ad campaign.

At step 406, the degree of similarity between the first set of users and the plurality of users is determined. In an embodiment, the second user selection module 216 determines the degree of similarity between the first set of users and the plurality of users based on a set of similarity parameters. In an embodiment, the set of similarity parameters comprises at least one of common user features, weights assigned to user features and one or more parameters associated with a social sharing graph.

At step 408, the plurality of users is ranked based on the degree of similarity. In an embodiment, the ranking module 226 assigns a top rank to a user with the highest degree of similarity. In an embodiment, the ranking module 226 assigns weights to the one or more characteristics for each of the plurality of users based on the one or more parameters associated with the predetermined data set 238. In an embodiment, the ranking module 226 uses one or more similarity functions to assign weights to the one or more characteristics.

At step 410, the social look-alike audience segment is determined. In an embodiment, the analysis module 218 determines the set of social look-alike users based, at least in part, on the ranking from the plurality of users.

FIG. 5 illustrates a method to determine a set of social look-alike users in accordance with another embodiment of the invention.

At step 502, the first set of users is selected from the plurality of users based on one or more log records. In an embodiment, the first user selection module 214 selects the first set of users from the plurality of users based on the one or more log records associated with preferably each of the plurality of users. The one or more log records are indicative of the at least one user activity on the at least one web page. In an embodiment, the one or more log records include a cookie, a timestamp, an event type, a sharing channel, a content identifier, domain information, and a browser agent. In an embodiment, the at least one user activity corresponds to a clicking activity, a sharing activity, a searching activity, and a web page view activity.

At step 504, the second set of users is selected for preferably each of the first set of users. In an embodiment, the second user selection module 216 selects the second set of users (from the plurality of users) for each of the first set of users based on at least one log record associated with each of the first set of users. In an embodiment, the first set of users and the second set of users have one or more common characterises. The one or more common characteristics comprises user interests and user activities.

At step 506, the set of social look-alike users is determined from the second set of users. In an embodiment, the analysis module 218 determines the set of social look-alike users from the second set of users based at least in part on the one or more log records associated with the second set of users and a predetermined data set. In an embodiment, the analysis module 218 further calculates a probability that a user in the set of social look-alike users will respond to a campaign associated with the predetermined data set, and subsequently generates the set of social look-alike users based on the probability.

FIG. 6 illustrates a flowchart illustrating a method to generate a social look-alike model in accordance with an embodiment of the invention.

At step 602, a predetermined data set is received. In an embodiment, the data extraction module 222 receives the predetermined data set from an advertising server 106. Further, the data extraction module 222 stores the received predetermined data set in the program data partition 210 as the predetermined data set 238. Concurrently, the data extraction module 222 extracts one or more log records associated with a plurality of users of the network 102. Based on the one or more log records, the social sharing graph manager 212 generates the social sharing graph.

At step 604, a first set of users is selected. In an embodiment, the first user selection module 214 selects the first set of users from a plurality of users depicted in the social sharing graph based on the predetermined data set 238. In an embodiment, the first set of users may include users that have responded to a campaign associated with the predetermined data. In another embodiment, the first set of users may include a list of users provided by the advertising server 106. In yet another embodiment, the predetermined data set includes the first set of users.

At step 606, a second set of users is selected to be a social look-alike audience segment. In an embodiment, the second user selection module 216 selects a second set of users. The second user selection module 216 analyzes one or more log records associated with the first set of users. Thereafter, based on the one or more log records associated with the first set of users, the second user selection module 216 selects the second set of users. Step 608 is discussed later.

FIG. 7 depicts an exemplary graph 700 illustrating selection of the second set of users in accordance with an embodiment of the invention. The graph 700 includes a user 702 from the first set of users. In an embodiment, the user 702 has shared web content with one or more users 704, 706, and 708 from the plurality of users depicted in the social sharing graph. The one or more users 704, 706, and 708 constitute the set of second users. Thus, the seed users (e.g., the first set of users) having sharing activities can activate any users by clicking on the shares. In an embodiment, the first set of users may include a user 710 that might have clicked on a web content that has been shared by one or more users 712 and 714 in the plurality of users. In such a case, the one or more users 712 and 714 that have shared the web content clicked by the user 710 would constitute the second set of users. Thus, the seed users (e.g., 710) having clicking activities can activate the users originating the shares (712 and 714). More generally, the seed users either having sharing or clicking activities can activate the users either clicking on or originating the shares. That is, all users connected to the seed users through either share or click links would constitute the second set of users. In an embodiment, the second set of users has one or more common characteristics with the first set of users. In another embodiment, the second set of users may be selected based on a content analysis of the one or more log records associated with the first set of users. For example, the first set of users include users that have performed one or more user activities on web content related to Macys® clothing product line. The second set of users may include users that have performed one or more user activities on web content related to clothing product lines other than Macys®.

In an embodiment, with the first set of users or seed users, one can identify the second set of users through social graph activation as detailed above. This second set of users, in the next iteration, can be used as seed users to identify another set of users. In this case, the users connected to the original seed users are regarded as distance-1 friends and the users connected to the distance-1 friends are regarded as distance-2 friends, and so on. Thus, the plurality of users is discovered from the closest to the farthest distance from the first set of users. At each distance, the newly discovered users, alone or combined with the users discovered at other distances, will be used to form the second set of users. The approach described so far is assumed to generate social look-alike users for a single campaign at a time. For practical applications, such as large-scale audience targeting for advertising campaigns, the method can be conveniently extended to accommodate multiple advertising campaigns in parallel by seed and graph annotations. This extension significantly reduces the computational complexity, as it requires only one pass on social graph traversal for all campaigns rather than a separate pass for each campaign.

FIG. 8 describes the flow chart of this parallel algorithm. A seed generation module is used to generate initial seed users 802 for multiple campaigns. At step 800, a set of seed users is selected from the predetermined dataset. Each seed user is annotated by labels from one or multiple campaigns and they comprise the initial seeds. The initial social sharing graph 806 is built at step 804, as detailed in social sharing graph manager 212. The graph annotation module is used to annotate the social sharing graph at step 808. At step 810, the initial social sharing graph is updated to incorporate annotations from the initial seed users 802. At step 812, a seed annotation module is used to activate new users directly connected with initial seed users in the updated social sharing graph and update the initial seed users by incorporating the new ones at step 814. The updated social sharing graph and seed users will be used as initial graph and seeds respectively for the next iteration 816. The newly discovered users at each iteration alone or combined with the users discovered at previous iterations, will be used at step 818 to form the user segments 820 for one or multiple targeted campaigns at step 818. Finally, the analysis module 218 is used to evaluate the user segments at step 822, as detailed in the later sections.

Returning to FIG. 6, at step 608, the social look-alike audience is analysed. In an embodiment, the analysis module 218 identifies a set of social look-alike users from the second set of users based on one or more log record associated with the second set of users and the predetermined data set 238. In an embodiment, the set of social look-alike users is selected based on the qualitative and quantitative analysis of one or more log records associated with the second set of users. In an embodiment, the set of social look-alike users may include users that have performed one or more user activities on web content related to clothing product lines other than Macys®. In an embodiment, the set of social look-alike users may include users that have purchasing power to afford Macys® clothing product line.

The analysis module 218 further calculates a probability for preferably each user in the set of social look-alike users that would respond to a campaign associated with the predetermined data set 238. In an embodiment, the analysis module 218 calculates marginal probability for preferably each user in the social look-alike users to segment the users in various groups. Finally, the social look-alike manager 220 generates a social look-alike model based on the probability associated with each user in the set of social look-alike users.

For example, the web analytic server 104 receives a request to identify a set of social look-alike users for Macys® clothing product line. Further, the web analytic server 104 receives an advertisement campaign data corresponding to the clothing product line of Macys®.

For identifying the set of social look-alike users, the first user selection module 214 analyzes one or more log records associated with the plurality of users of the Internet. Thereafter, the first user selection module 214 determines a first set of log records that include information related to the clothing product line of Macys®. Based on the first set of log records, the first user selection module 214 identifies a first set of users associated with the first set of log records. In an embodiment, the first set of users includes users that have shared or clicked on a web content related to the clothing product line of Macys®.

Subsequently, the second user selection module 216 determines a second set of users from all users on the internet based on one or more log records associated with the first set of users. The first and the second set of users may have one or more characteristics in common. For example, the second set of users may include users that regularly browse through clothing product line of brands other than Macys®. Further, the second set of users may include users that browse through web content. In an embodiment, the second set of users might have shared or clicked on the web content related to the clothing products.

Thereafter, the analysis module 218 identifies a set of social look-alike users from the second set of users based on one or more log records associated with the second set of users and the advertisement campaign data. The set of social look-alike users include users that might be interested in the clothing product line of Macys®. Further, the analysis module 218 calculates probability of interest in the clothing product line of Macys® for each user in the set of social look-alike users. In an embodiment, the probability associated with each user in the social look-alike set of users is depicted by the equation below:

Probability of interest in Macys clothing for a user in the set of social look-alike users=P(Macys clothing campaign data|user) (1)

Based on the probability for preferably each user in the set of social look-alike users, the social look-alike manager 220 generates a social look-alike model as shown in FIG. 3.

The disclosed methods and systems, as described in the ongoing description or any of its components, may be embodied in the form of a computer system. Typical examples of a computer system include, but are not limited to, a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, and a display unit. The computer further comprises a microprocessor. The microprocessor is connected to a communication bus. The computer also includes a memory. The memory may be a Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system also typically includes a communication unit. The communication unit allows the computer to connect to other databases and the Internet through an Input/output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through input device, accessible to the system through an I/O interface.

The computer system executes a set of instructions that are stored in one or more storage elements in order to process input data. The storage elements may also hold data or other information as desired. The storage element may be in the form of an information source or a physical memory element present in the processing machine.

The programmable or computer readable instructions may include various commands that instruct the processing machine to perform specific tasks such as the steps that constitute the method of the present invention. The method and systems described can also be implemented using only software programming or using only hardware or by a varying combination of the two techniques. The disclosed invention is independent of the programming language used and the operating system in the computers. The instructions for the invention can be written in all programming languages including, but not limited to ‘C’, ‘C++’, ‘Visual C++’ and ‘Visual Basic’, Java™, Python. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS’, ‘Android’, ‘Symbian’, and ‘Linux’.

The programmable instructions can be stored and transmitted on a non-transitory computer readable medium. The programmable instructions can also be transmitted by data signals across a carrier wave. The disclosed invention can also be embodied in a computer program product comprising a non-transitory computer readable medium, the product capable of implementing the above methods and systems, or the numerous possible variations thereof.

While various embodiments have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A computer-implemented method for identifying a set of social look-alike users from a plurality of users accessing a plurality of web pages, the computer-implemented method comprising:
selecting a first set of users from the plurality of users based, at least in part, on one or more characteristics associated with the plurality of users;
determining a degree of similarity between the first set of users and the plurality of users;
ranking the plurality of users based on the degree of similarity; and
determining the set of social look-alike users from the ranking.

2. The computer-implemented method of claim 1, wherein the degree of similarity is selected from at least one of common user features, user feature weights and a social sharing graph.

3. The computer-implemented method of claim 1, wherein the set of social look-alike users are determined based on a look-alike profile of the first set of users, and proximity distance of the plurality of users from the first set of users.

4. A computer-implemented method for identifying a set of social look-alike users from a plurality of users accessing a plurality of web pages, the computer-implemented method comprising:
selecting a first set of users from the plurality of users based, at least in part, on weights assigned to one or more characteristics associated with the plurality of users, wherein the weights are assigned to the one or more characteristics based on one or more features of an ad campaign, wherein the first set of users have one or more common characteristics;
determining a degree of similarity between the first set of users and the plurality of users;
ranking the plurality of users based on the degree of similarity; and
determining the set of social look-alike users from the ranked plurality of users.

5. The computer-implemented method of claim 4 further comprising determining the one or more characteristics based, at least in part, on one or more log records associated with the plurality of users, wherein the one or more log records are indicative of at least one user activity on at least one of the plurality of web pages.

6. The computer-implemented method of claim 5, wherein the one or more log records comprises at least one of a cookie, a timestamp, an event type, a sharing channel, a content identifier, a domain information and a browser agent.

7. The computer-implemented method of claim 5, wherein the at least one user activity comprises at least one of a clicking activity, a sharing activity, a searching activity and a web page view activity.

8. The computer-implemented method of claim 5, wherein the one or more characteristics comprises at least one of user interests, user response behaviour, social events, user feature data and user activities.

9. The computer-implemented method of claim 4, wherein the one or more features of the campaign comprises at least one of content of the campaign, duration of the ad campaign, and websites publishing the ad campaign.

10. A web analytic server for identifying a set of social look-alike users from a plurality of users accessing a plurality of web pages, the web analytic server comprising:
a first user selection module configured to select a first set of users from the plurality of users based at least in part on weights assigned to one or more characteristics associated with the plurality of users, wherein the weights are assigned based on one or more features of a campaign, users in the first set of users having one or more common characteristics; and
an analysis module configured to determine the set of social look-alike users from the plurality of users based, at least in part, on the one or more common characteristics.

11. The web analytic server of claim 10 further comprising a user profile creation module configured to create a user profile for the plurality of users based on the one or more characteristics, the one or more characteristics being determined based at least in part on one or more log records associated with the plurality of users, the one or more log records indicative of at least one user activity on at least one web page.

12. The web analytic server of claim 11, wherein the one or more log records comprises at least one of a cookie, a timestamp, an event type, a sharing channel, a content identifier, a domain information and a browser agent.

13. The web analytic server of claim 11, wherein the at least one user activity comprises at least one of a clicking activity, a sharing activity, a searching activity and a web page view activity.

14. The web analytic server of claim 11, wherein the one or more characteristics comprises at least one of user interests and user activities.

15. The web analytic server of claim 10, wherein the one or more features of the campaign comprises at least one of content of the campaign, duration of the campaign, and websites publishing the campaign.

16. A web analytic server for identifying a set of social look-alike users from a plurality of users accessing a plurality of web pages, the web analytic server comprising:
a first user selection module configured to select a first set of users from the plurality of users based on one or more log records associated with the plurality of users, the one or more log records indicative of at least one user activity on at least one web page, the at least one user activity comprising a sharing or clicking activity;
a second user selection module configured to select from the plurality of users a second set of users for the first set of users based at least in part on the at least one log record associated with the first set of users, wherein the second set of users and the first set of users have one or more common characteristics; and
an analysis module configured to determine the set of social look-alike users from the second set of users based, at least in part, on one or more log records associated with the second set of users and a predetermined data set.

17. The web analytic server of claim 16, wherein the at least one user activity comprises at least one of a clicking activity, the sharing activity, a searching activity and a web page view activity.

18. The web analytic server of claim 16, wherein the one or more log records comprises at least one of a cookie, a timestamp, an event type, a sharing channel, a content identifier, a domain information and a browser agent.

19. The web analytic server of claim 16, wherein the one or more common characteristics comprises at least one of user interests and user activities.

20. The web analytic server of claim 16, wherein the predetermined data set correspond to at least one of an advertisement campaign data, and survey data.

21. The web analytic server of claim 16, wherein the analysis module calculates a probability that a user in the set of social look-alike users will respond to a campaign associated with the predetermined data set.

22. The web analytic server of claim 16, further comprising a social look-alike manager configured to generate a social look-alike model based, at least in part, on the probability and the set of social look-alike users.

23. A computer-implemented method for identifying a set of social look-alike users from a plurality of users accessing a plurality of web pages, the computer-implemented method comprising:
selecting a first set of users from the plurality of users based on one or more log records associated with the plurality of users, the one or more log records indicative of at least one user activity on at least one web page, the at least one user activity comprising a sharing or clicking activity;
selecting a second set of users for the first set of users based, at least in part, on at least one log record associated with the first set of users, wherein the second set of users and the first set of users have one or more common characteristics; and
determining the set of social look-alike users from the second set of users based, at least in part, on one or more log records associated with the second set of users and a predetermined data set.

24. The computer-implemented method of claim 23 further comprising calculating a probability that a user in the set of social look-alike users will respond to a campaign associated with the predetermined data set.

25. The computer-implemented method of claim 23, wherein the at least one user activity corresponds to at least one of a clicking activity, a sharing activity, a searching activity and a web page view activity.

26. The computer-implemented method of claim 23, wherein the one or more log records comprises at least one of a cookie, a timestamp, an event type, a sharing channel, a content identifier, a domain information and a browser agent.

27. A computer-implemented method for generating a social look-alike model, the computer-implemented method comprising:
selecting a first set of users from a plurality of users based, at least in part, on one or more log records, the one or more log records being indicative of at least one user activity, the at least one user activity comprising a sharing or clicking activity;
selecting a second set of users based, at least in part, on the first set of users and at least one log record associated with the first set of users;
selecting a set of social look-alike users from the second set of users based, at least in part, on one or more log records associated with the second set of users and a predetermined data set;
calculating a probability that a user in the set of social look-alike users will respond to a campaign based, at least in part, on the predetermined data set; and
generating the social look-alike model based, at least in part on, the probability and the set of social look-alike users.

28. A computer program product for use with a computer, the computer program product comprising a computer readable program code embodied in a non-transitory medium for identifying a set of social look-alike users from a plurality of users accessing a plurality of web pages, the computer readable program code comprising:
program instructions for selecting a first set of users from the plurality of users based, at least in part, on one or more characteristics associated with the plurality of users;
program instructions for determining a degree of similarity between the first set of users and the plurality of users;
program instructions for ranking the plurality of users based on the degree of similarity; and
program instructions for determining the set of social look-alike users from the ranking.
